(19) United States
(12) Patent Application Publication
(10) Pub. No.: US 2026/0189039 A1
(43) Pub. Date: Jul. 2, 2026

(54) Power Terminal, Power Terminal Assembly and Charging Dock

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Fangyue (Jason) Zhu, Shanghai (CN); Jinshun (Jet) Wang, Suzhou (CN); Haifei (Felix) Yu, Suzhou (CN); Renyi (Ronny) Dou, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/437,513

(22) Filed: Dec. 31, 2025

(30) Foreign Application Priority Data
Dec. 31, 2024 (CN) 202411998276.3

(51) Int. Cl. H02J 7/70

(52) U.S. Cl. CPC H02J 7/70

(57) ABSTRACT

A power terminal for a charging dock comprises a cylindrical part, a welding part and a high-voltage cable. The cylindrical part is adapted to mate with a mating power terminal. The welding part is connected to a rear end of the cylindrical part and is adapted to be welded to a high-voltage cable. The welding part is flat and has first and second sides opposite in its thickness direction. The first side of the welding part is adapted to be welded to the high-voltage cable. A local protrusion is formed on the second side of the welding part and is adapted to be in thermal contact with a thermal pad of the charging dock, such that the heat of the power terminal can be transferred to a temperature sensor of the charging dock.

### CROSS-REFERENCE TO RELATED APPLICATION

This application claims the benefit of Chinese Patent Application No. CN202411998276.3 filed on Dec. 31, 2024 in the State Intellectual Property Office of China, the whole disclosure of which is incorporated herein by reference.

FIELD OF THE INVENTION

The disclosure relates to the field of electric vehicle charging technology, particularly to a power terminal, a power terminal assembly comprising the power terminal, and a charging dock comprising the power terminal assembly.

### BACKGROUND OF THE INVENTION

In the prior art, a power terminal of a charging dock usually includes a cylindrical part for mating with the mating power terminal and a welding end for welding to the high-voltage cable. A thermal pad is usually in thermal contact with the outer circumferential surface of the cylindrical part of power terminal. However, due to the proximity of the thermal pad to the rear of the charging dock housing, it is necessary to extend the length of the cylindrical part of the power terminal so that it extends into the rear of the charging dock housing to make contact with the thermal pad. This will result in a larger volume and higher cost of power terminals.

In addition, in the prior art, the positive earth or PE terminal (also known as a grounding protection terminal) and A-terminal (also known as a negative terminal of a low-voltage auxiliary power supply) in the DC charging dock are separately provided, which leads to the PE terminal and A-terminal not being grounded together, that is, the PE terminal and A-terminal are not electrically interconnected and grounded together. Therefore, in practical applications, sometimes there may be a large voltage difference between the DC charging dock and the DC charging gun due to the PE terminal and A-terminal not being grounded together. This can lead to a large current in the low-voltage auxiliary circuit connected to the A+ terminal or A-terminal of the DC charging dock, which can easily cause the low-voltage auxiliary circuit to be burned out.

In addition, in the prior art, in order to improve the charging speed of new energy electric vehicles, it is necessary to increase the charging current. Currently, the charging current is as high as 600 A, and it may even increase to 1000 A in the future. When a large current flows through the power terminal of the DC charging dock, a large amount of heat will be generated, which will cause the temperature of the power terminal of the DC charging dock to rise sharply. If the temperature rise cannot be controlled in time, it will lead to safety accidents, such as burning the DC charging dock or other electrical equipment.

In addition, in the prior art, in order to control the temperature rise of power terminals, a lead frame is usually installed in the DC charging dock and a Low-voltage module is integrated on the lead frame. The low-voltage module of the DC charging dock includes a temperature sensor and a thermal pad wrapped around the temperature sensor. The thermal pad is in thermal contact with the power terminal, and the temperature sensor is electrically connected to the lead frame. However, in the prior art, the lead frame has a large volume and needs to be pre-installed in the charging dock housing, which is inconvenient to use. In addition, in the prior art, in order to facilitate the installation of lead frame, the charging dock housing needs to adopt a split design, which leads to a complex structure of the charging dock housing. In addition, the existing lead frame needs to be able to rotate between the locking position of locking the power terminal and the unlocking position of unlocking the power terminal, which will make the lead frame and charging dock housing more complex, assembly more difficult, and cost higher.

### SUMMARY OF THE INVENTION

According to an embodiment of the present disclosure, a power terminal for a charging dock comprises a cylindrical part, a welding part and a high-voltage cable. The cylindrical part is adapted to mate with a mating power terminal. The welding part is connected to the rear end of the cylindrical part and is adapted to weld to a high-voltage cable. The welding part is flat and has first and second sides opposite in its thickness direction, the first side of the welding part is used for welding to the high-voltage cable. A local protrusion is formed on the second side of the welding part and is adapted to be in thermal contact with the thermal pad of the charging dock, such that the heat of the power terminal can be transferred to a temperature sensor of the charging dock through the thermal pad.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a charging dock according to an exemplary embodiment of the present invention;

FIG. 2 shows an illustrative exploded view of a charging dock according to an exemplary embodiment of the present invention;

FIG. 3 shows an illustrative perspective view of a low-voltage module, PE terminal, A-terminal, and power terminal according to an exemplary embodiment of the present invention;

FIG. 4 shows an illustrative exploded view of a low-voltage module and power terminal according to an exemplary embodiment of the present invention;

FIG. 5 shows an illustrative perspective view of a low-voltage module, PE terminal, and A-terminal when viewed from the front side according to an exemplary embodiment of the present invention;

FIG. 6 shows an illustrative perspective view of a low-voltage module, PE terminal, and A-terminal when viewed from the rear according to an exemplary embodiment of the present invention;

FIG. 7 shows an illustrative exploded view of a low-voltage module, PE terminal, and A-terminal according to an exemplary embodiment of the present invention;

FIG. 8 shows an illustrative perspective view of a low-voltage module according to an exemplary embodiment of the present invention;

FIG. 9 shows an illustrative exploded view of a low-voltage module according to an exemplary embodiment of the present invention;

FIG. 10 shows another illustrative exploded view of a low-voltage module according to an exemplary embodiment of the present invention;

FIG. 11 shows an illustrative perspective view of the conductive leads and temperature sensor of a low-voltage module according to an exemplary embodiment of the present invention;

FIG. 12 shows an illustrative perspective view of a low-voltage module according to an exemplary embodiment of the present invention;

FIG. 13 shows an illustrative perspective view of the electrical connection members of a low-voltage module according to an exemplary embodiment of the present invention;

FIG. 14 shows an illustrative view of the electrical connection of the low-voltage module in electrical contact with the PE terminal and A-terminal according to an exemplary embodiment of the present invention;

FIG. 15 shows an illustrative perspective view of the power terminal of a charging dock according to an exemplary embodiment of the present invention;

FIG. 16 shows an axial sectional view of the power terminal of a charging dock according to an exemplary embodiment of the present invention;

FIG. 17 shows a side view of the power terminal of a charging dock according to an exemplary embodiment of the present invention; and

FIG. 18 shows a side view of the power terminal assembly of a charging dock according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a power terminal for a charging dock comprises: a cylindrical part, used for mating with a mating power terminal; and a welding part which is connected to the rear end of the cylindrical part and is used for welding to a high-voltage cable. The welding part is flat and has first and second sides opposite in its thickness direction, the first side of the welding part is used for welding to the high-voltage cable, a local protrusion is formed on the second side of the welding part, which is used for thermal contact with the thermal pad of the charging dock, so that the heat of the power terminal can be transferred to a temperature sensor of the charging dock through the thermal pad.

According to another embodiment, a power terminal assembly comprises: the above power terminal; and a high-voltage cable, one end of which is welded to the first side of the welding part of the power terminal. According to another embodiment, a charging dock comprises: a charging dock housing which is formed with a socket; and the above power terminal assembly inserted into the socket.

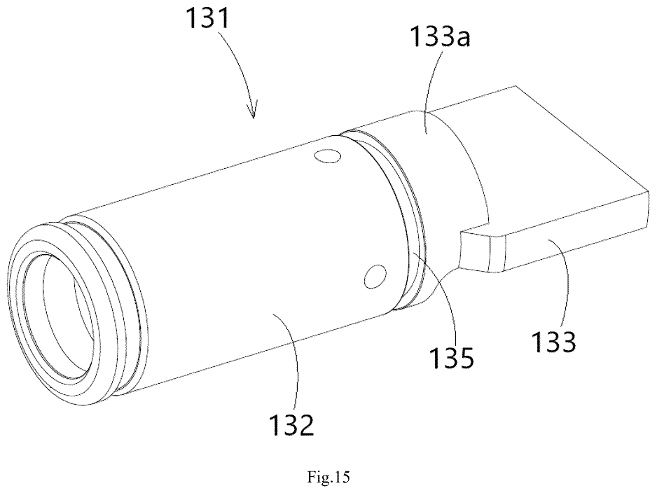

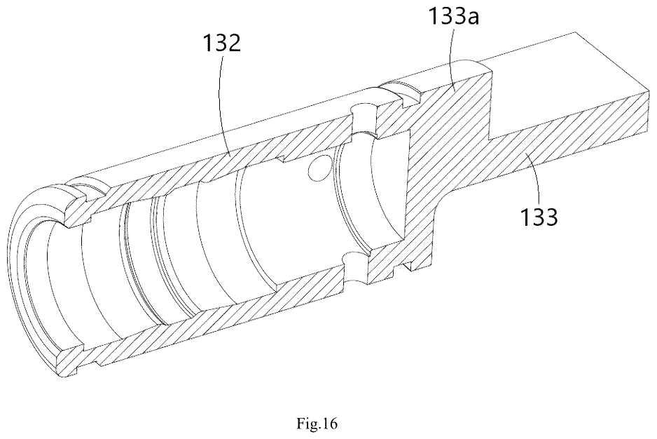

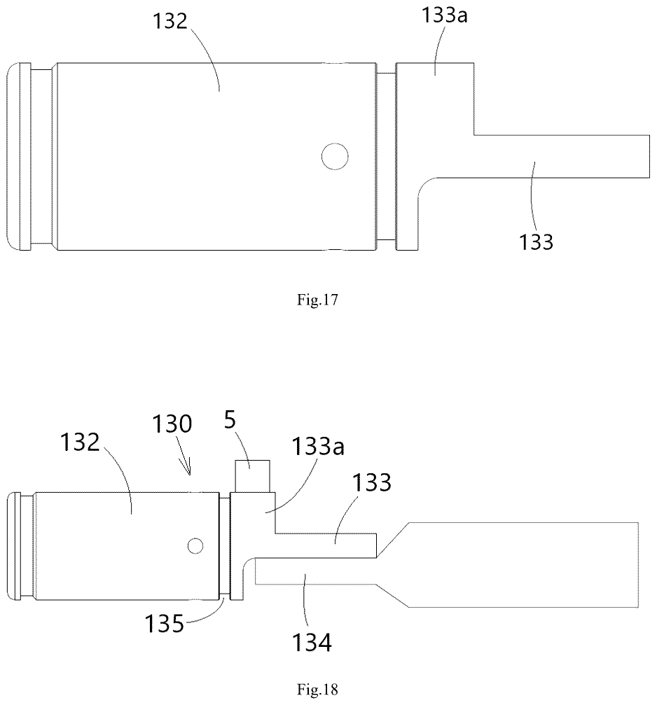

FIG. 15 shows an illustrative perspective view of the power terminal 131 of a charging dock according to an exemplary embodiment of the present invention. FIG. 16 shows an axial sectional view of the power terminal 131 of a charging dock according to an exemplary embodiment of the present invention. FIG. 17 shows a side view of the power terminal 131 of a charging dock according to an exemplary embodiment of the present invention. FIG. 18 shows a side view of the power terminal assembly 130 of a charging dock according to an exemplary embodiment of the present invention.

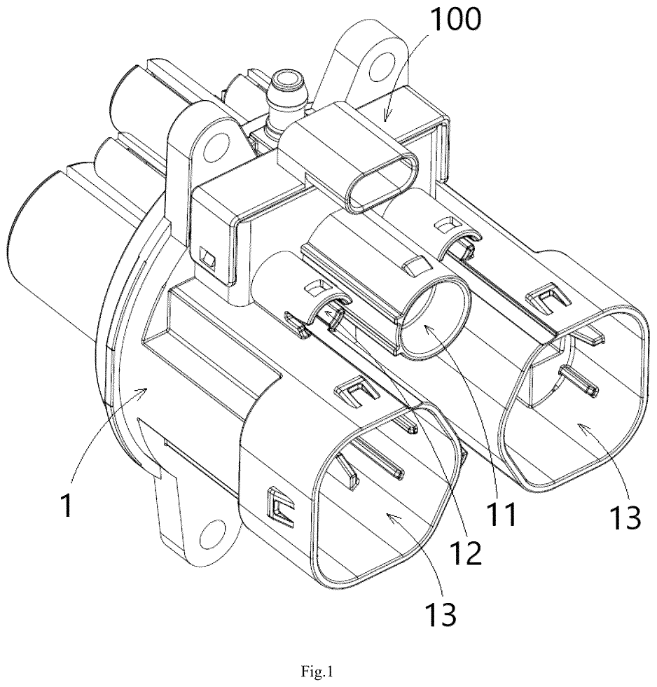

As shown in FIGS. 15-18, in an exemplary embodiment of the present invention, a power terminal 131 for a charging dock is disclosed. The power terminal 131 includes a cylindrical part 132 and a welding part 133. The cylindrical part 132 is used for mating with a mating power terminal (not shown). The welding part 133 is connected to the rear end of the cylindrical part 132 for welding to a high-voltage cable 134. The welding part 133 is flat and has first and second sides opposite in its thickness direction. The first side of the welding part 133 is used for welding to the high-voltage cable 134. A local protrusion 133a is formed on the second side of the welding part 133, which is used for thermal contact with a thermal pad 5 (see FIGS. 1 to 14) of the charging dock, so that the heat of the power terminal 131 can be transferred to the temperature sensor 4 (see FIGS. 1 to 14) of the charging dock through the thermal pad 5. In the illustrated embodiment, the local protrusion 133a may have a semi cylindrical shape or other suitable shape.

In the embodiments shown, as the local protrusion 133a in thermal contact with the thermal pad 5 is formed on the welding part 133 of the power terminal 131, there is no need to extend the cylindrical part 132 of the power terminal 131 backwards, thereby reducing the axial length of the power terminal 131, decreasing its volume and manufacturing cost. The local protrusion 133a is adjacent to or connected to the rear end of the cylindrical part 132 of the power terminal 131. However, the present invention is not limited to the illustrated embodiment. For example, the local protrusion 133a may be spaced apart from the rear end of the cylindrical part 132 of the power terminal 131 by a predetermined distance. In the illustrated embodiment, the power terminal 131 is an integral machined part or an integral stamped part. In another exemplary embodiment of the present invention, a power terminal assembly 130 is also disclosed. The power terminal assembly 130 includes a power terminal 131 and a high-voltage cable 134. One end of the high-voltage cable 134 is welded to the first side of the welding part 133 of the power terminal 131.

The power terminal assembly 130 further includes a sealing ring (not shown) that is fitted onto the cylindrical part 132 of the power terminal 131. The sealing ring is suitable for being compressed between the cylindrical part 132 of the power terminal 131 and the inner wall surface of the socket 13 of the charging dock housing 1 to achieve sealing between the two. A seal installation groove 135 is formed on the cylindrical part 132 of the power terminal 131, and the aforementioned sealing ring is installed in the seal installation groove 135.

The power terminal assembly further includes a sealing plug (not shown) that is fitted onto the high-voltage cable 134. The sealing plug is adapted to be compressed between the high-voltage cable 134 and the inner wall surface of the socket 13 of the charging dock housing 1 to achieve sealing between the two.

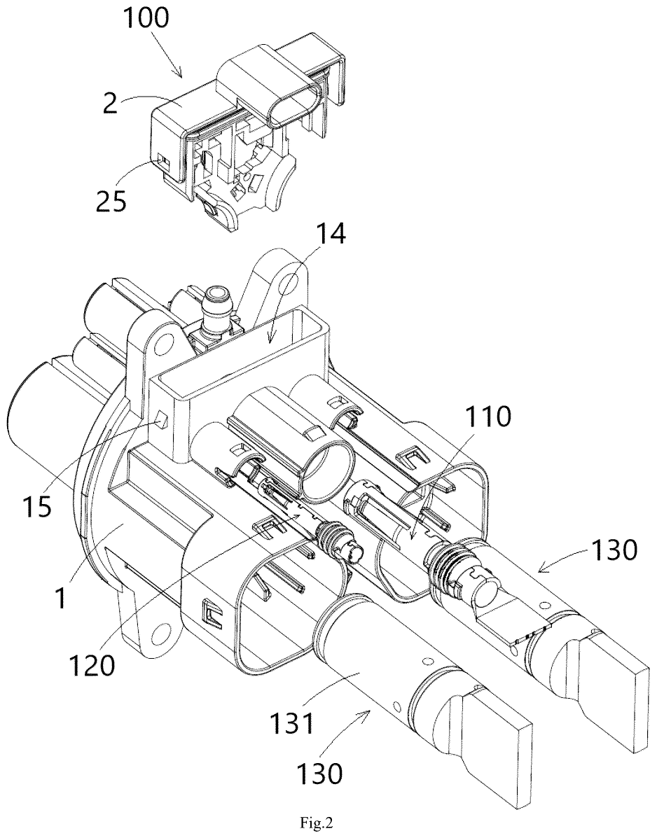

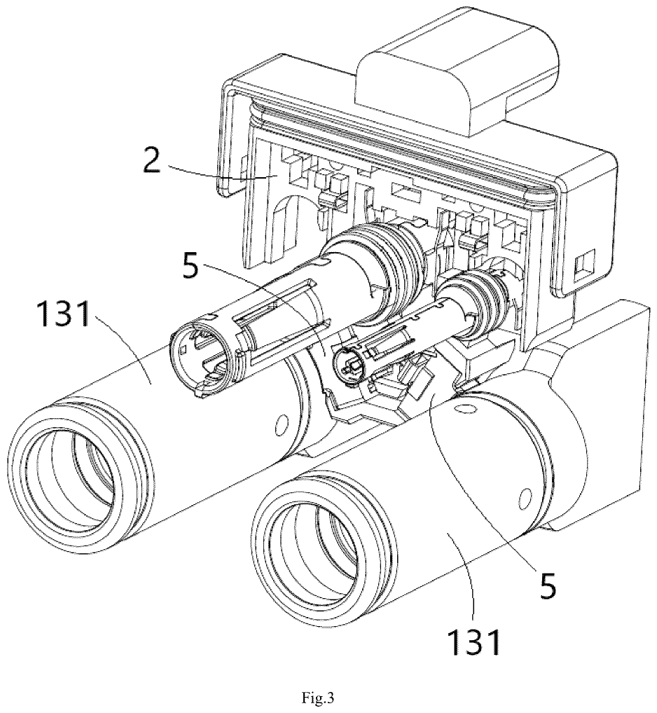

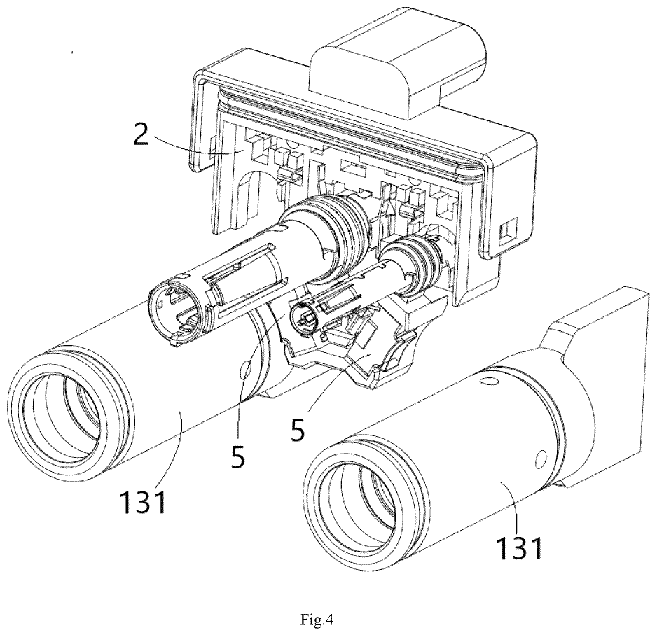

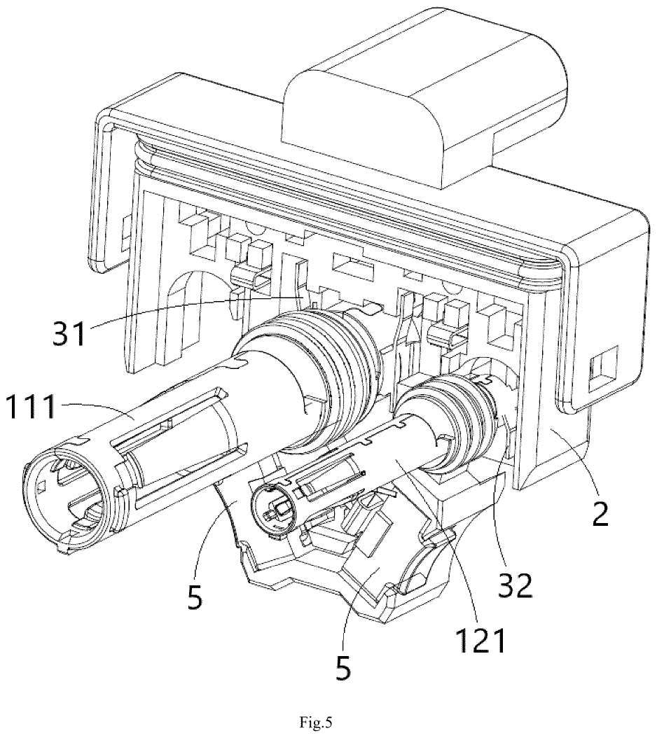

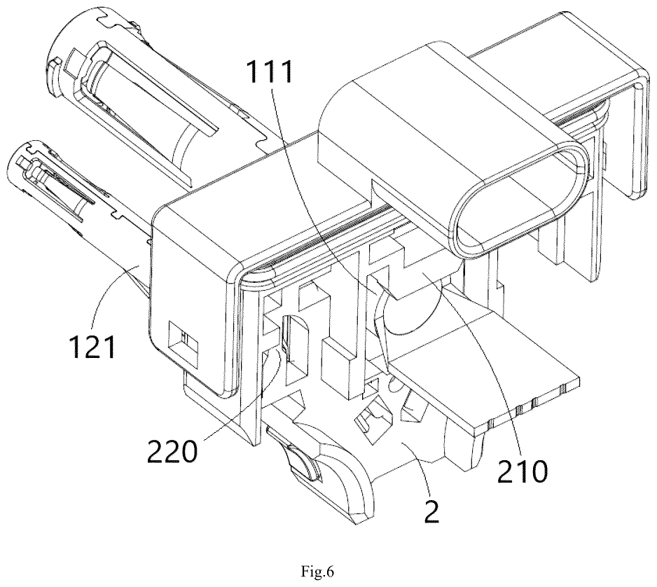

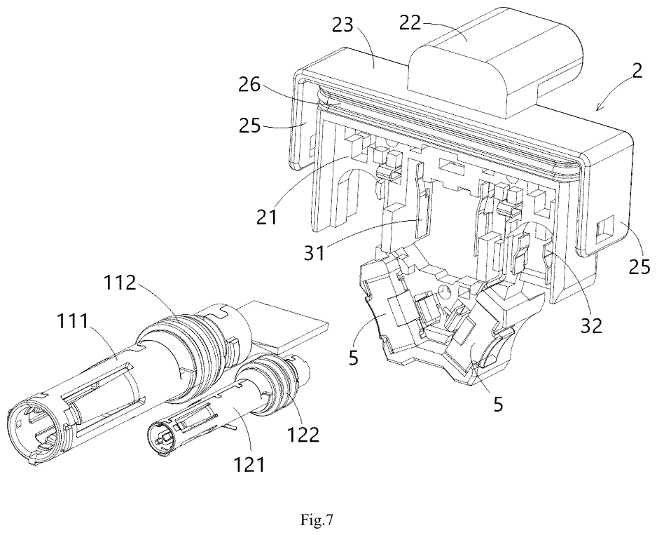

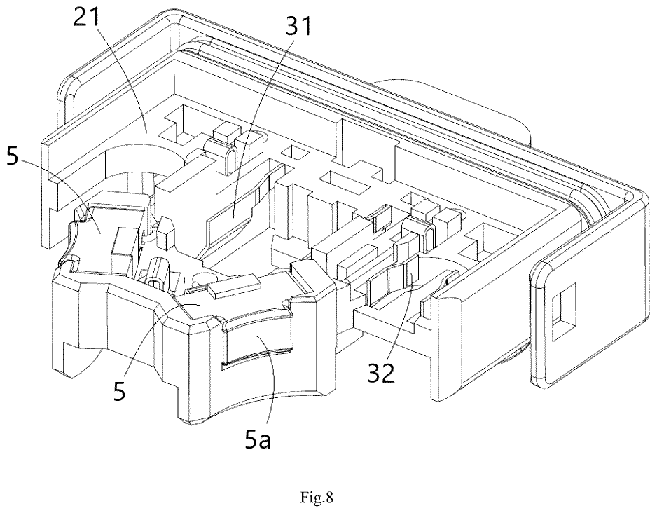

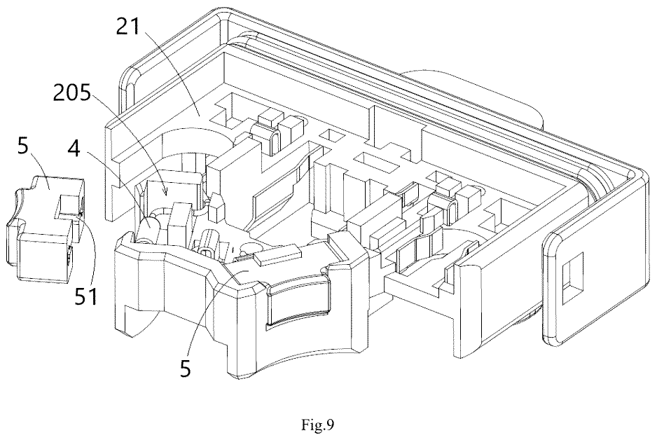

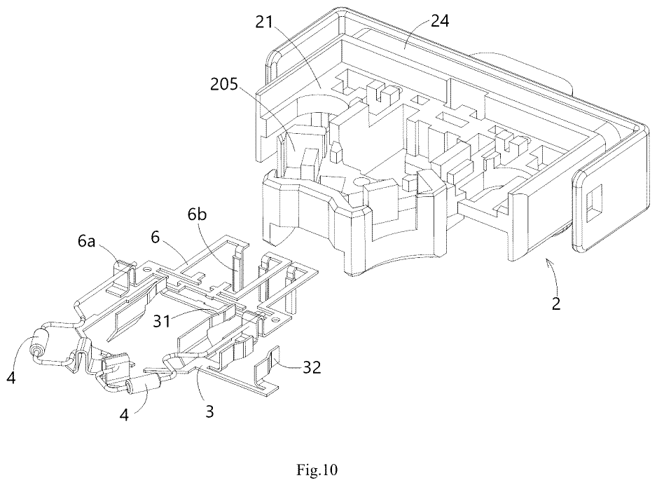

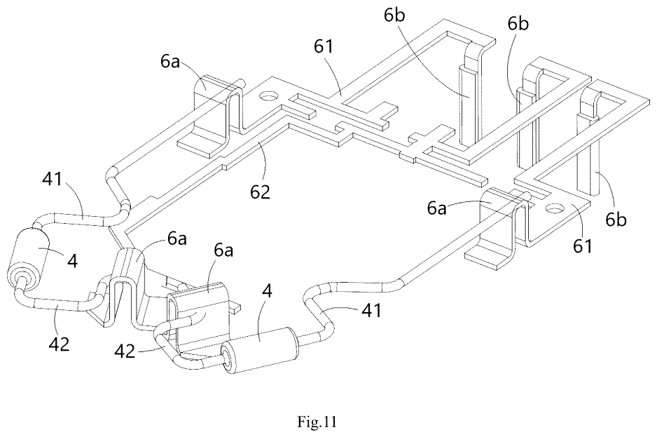

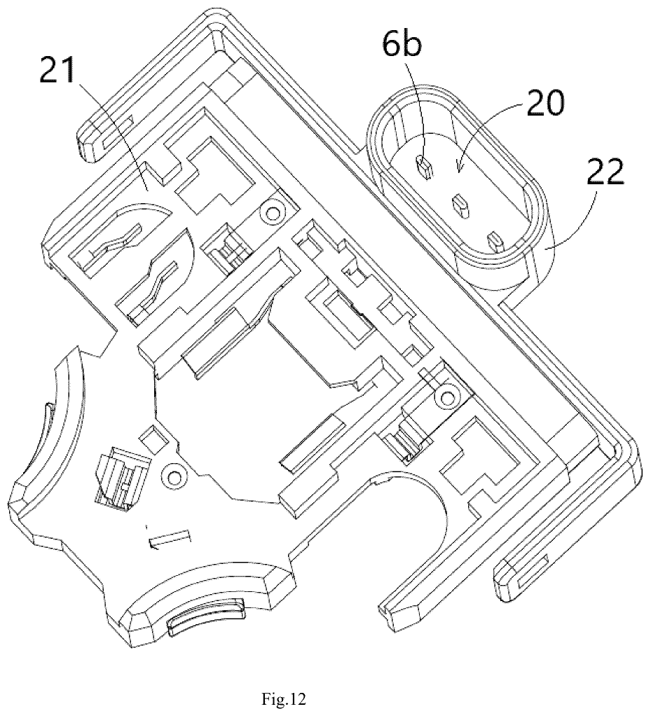

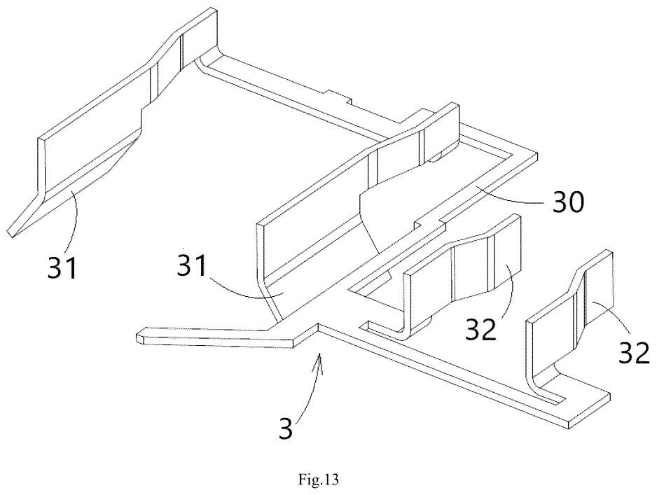

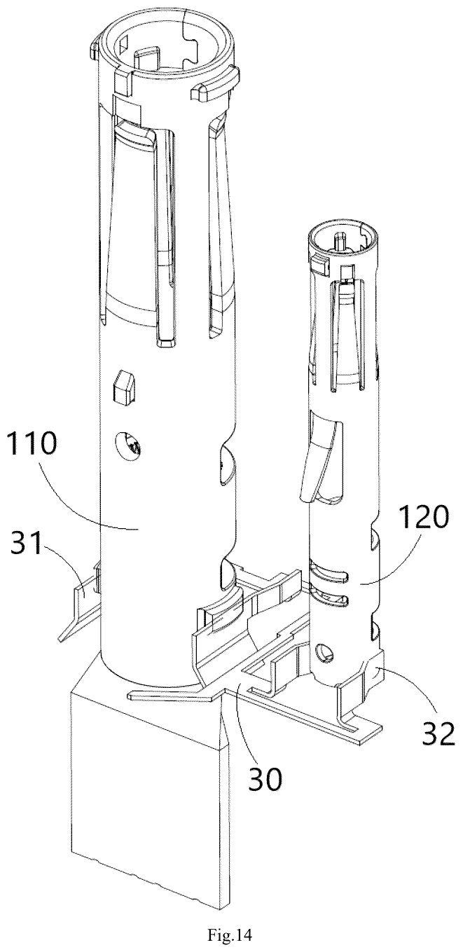

FIG. 1 shows an illustrative perspective view of a charging dock according to an exemplary embodiment of the present invention. FIG. 2 shows an illustrative exploded view of a charging dock according to an exemplary embodiment of the present invention. FIG. 3 shows an illustrative perspective view of a low-voltage module 100, PE terminal 111, A-terminal 121, and power terminal 131 according to an exemplary embodiment of the present invention. FIG. 4 shows an illustrative exploded view of a low-voltage module 100 and a power terminal 131 according to an exemplary embodiment of the present invention. FIG. 5 shows an illustrative perspective view of the low-voltage module 100, PE terminal 111, and A-terminal 121 when viewed from the front side according to an exemplary embodiment of the present invention. FIG. 6 shows an illustrative perspective view of the low-voltage module 100, PE terminal 111, and A-terminal 121 when viewed from the rear according to an exemplary embodiment of the present invention. FIG. 7 shows an illustrative exploded view of a low-voltage module 100, PE terminal 111, and A-terminal 121 according to an exemplary embodiment of the present invention. FIG. 8 shows an illustrative perspective view of a low-voltage module 100 according to an exemplary embodiment of the present invention. FIG. 9 shows an illustrative exploded view of a low-voltage module 100 according to an exemplary embodiment of the present invention. FIG. 10 shows another illustrative exploded view of a low-voltage module 100 according to an exemplary embodiment of the present invention. FIG. 11 shows an illustrative perspective view of the conductive lead 6 and temperature sensor 4 of the low-voltage module 100 according to an exemplary embodiment of the present invention. FIG. 12 shows an illustrative perspective view of a low-voltage module 100 according to an exemplary embodiment of the present invention. FIG. 13 shows an illustrative perspective view of the electrical connection member 3 of the low-voltage module 100 according to an exemplary embodiment of the present invention. FIG. 14 shows an illustrative view of the electrical connection 3 of the low-voltage module 100 in electrical contact with the PE terminal 111 and A-terminal 121 according to an exemplary embodiment of the present invention.

As shown in FIGS. 1-18, in another exemplary embodiment of the present invention, a charging dock is also disclosed. The charging dock includes a charging dock housing 1 and the aforementioned power terminal assembly 130. The charging dock housing 1 is formed with a socket 13. The power terminal assembly 130 is inserted into the socket 13 of the charging dock housing 1. Multiple sockets 13 are formed in the charging dock housing 1, and the charging dock includes multiple power terminal assemblies 130 that are respectively inserted into the multiple sockets 13. An insertion slot 14 communicated with the socket 13 is formed in the charging dock housing 1. The charging dock also includes a low-voltage module 100 for detecting the temperature of the power terminal 131. The low-voltage module 100 is installed in a pluggable manner from the outside of the charging dock housing 1 into the insertion slot 14 in the charging dock housing 1. In one embodiment, the charging dock housing 1 is an integral injection molded part.

The low-voltage module 100 includes an insulator 2, a thermal pad 5, a temperature sensor 4, and a conductive lead 6. The thermal pad 5 is assembled onto the insulator 2 for thermal contact with the local protrusion 133a of the power terminal 131. The temperature sensor 4 is provided in thermal pad 5 to detect the temperature of the power terminal 131. The conductive lead 6 is set in the insulator 2 and electrically connected to the temperature sensor 4. The thermal pad 5 is in thermal contact with the local protrusion 133a of the power terminal 131 to transfer the heat of the power terminal 131 to the temperature sensor 4.

In the illustrated embodiment, the insulator 2 is directly injection molded onto the conductive lead 6, making the conductive lead 6 and the insulator 2 an integrated piece. The conductive lead 6 has a connection end 6a for electrical connection with the temperature sensor 4 and an external pin 6b for electrical connection with a connector (not shown) located outside the charging dock housing 1.

The insulator 2 includes a bracket part 21 and a mating part 22. The bracket part 21 is suitable for inserting into the insertion slot 14 of the charging dock housing 1. The mating part 22 is adapted to be positioned on the outside of the charging dock housing 1. The thermal pad 5 and temperature sensor 4 are installed on the bracket part 21, and the mating part 22 has an insertion cavity 20 that allows the connector to be inserted. The external pin 6b of the conductive lead 6 extends into the insertion cavity 20 to electrically connect with the inserted connector.

A sealing ring installation groove 24 is formed on the outer peripheral surface of the bracket part 21. The low-voltage module 100 also includes a sealing ring 26 installed in the sealing ring installation groove 24, which is suitable for being compressed between the bracket part 21 and the inner wall surface of the insertion slot 14 of the charging dock housing 1 to achieve sealing between the two.

The bracket part 21 has a cover plate part 23 for covering the entrance of the insertion slot 14 of the charging dock housing 1, and the insulator 2 also includes multiple buckles 25 connected to the periphery of the cover plate part 23, which are distributed around the outer periphery of the cover plate part 23 at intervals. Multiple protrusions 15 are formed on the outer side of the peripheral wall of the insertion slot 14 of the charging dock housing 1. These protrusions 15 are distributed around the insertion slot 14 at intervals and are respectively engaged with multiple buckles 25 to lock the low-voltage module 100 to the charging dock housing 1.

The conductive lead 6 includes a positive lead 61 and a negative lead 62 electrically connected to the positive pin 41 and the negative pin 42 of the temperature sensor 4, respectively. The external pins 6b of the positive lead 61 and the negative lead 62 extend into the insertion cavity 20 of the mating part 22 for electrical connection with the inserted connector.

The connection end 6a of the positive lead 61 is adapted to be electrically connected to the positive pin 41 of the temperature sensor 4 in a pluggable manner. The connection end 6a of the negative lead 62 is suitable for plug-in electrical connection with the negative pin 42 of the temperature sensor 4.

The connection end 6a of the positive lead 61 is in an elastic clip shape, suitable for clamping the positive pin 41 of the temperature sensor 4. The connection end 6a of the negative lead 62 is in an elastic clip shape, suitable for clamping the negative pin 42 of the temperature sensor 4. However, the present invention is not limited to the illustrated embodiments. For example, the connection end 6a of the positive lead 61 may be welded or crimped to the positive pin 41 of the temperature sensor 4, and the connection end 6a of the negative lead 62 may be welded or crimped to the negative pin 42 of the temperature sensor 4.

The low-voltage module 100 includes multiple thermal pads 5 and multiple temperature sensors 4 respectively arranged in the multiple thermal pads 5. The multiple thermal pads 5 are used to make thermal contact with multiple power terminals 131, and the multiple temperature sensors 4 are used to detect the temperature of the multiple power terminals 131.

The conductive lead 6 includes multiple positive leads 61 and a single negative lead 62. The connection ends 6a of multiple positive leads 61 are electrically connected to the positive pins 41 of multiple temperature sensors 4, and the single negative lead 62 has multiple connection ends 6a electrically connected to the negative pins 42 of multiple temperature sensors 4. The external pins 6b of multiple positive leads 61 and the external pin 6b of the single negative lead 62 extend into the insertion cavity 20 of the mating part 22 for electrical connection with the inserted connector.

The thermal pad 5 is in the form of a block, and a recessed receiving part 205 is formed on the insulator 2. The thermal pad 5 is positioned and installed in the receiving part 205. A mounting slot 51 is formed in the thermal pad 5, and the main body of the temperature sensor 4 is inserted into the mounting slot 51 of the thermal pad 5. The positive pin 41 and negative pin 42 of the temperature sensor 4 extend from the thermal pad 5. The thermal pad 5 has an arc-shaped contact surface 5a suitable for being attached to the outer peripheral surface of the power terminal 131 to increase the thermal contact area between the thermal pad 5 and the power terminal 131.

A first socket 11 and a second socket 12 are formed in the charging dock housing 1, and the insertion slot 14 is communicated with the first socket 11 and the second socket 12. In the illustrated embodiment, the charging dock is a DC charging dock, which further includes a PE terminal assembly 110 and an A-terminal assembly 120. The PE terminal assembly 110 includes a PE terminal (or ground protection terminal) 111 and is inserted into the first socket 11. The A-terminal assembly 120 includes an A-terminal (or referred to as the negative terminal of the low-voltage auxiliary power supply) 121 and is inserted into the second socket 12. The low-voltage module 100 also includes an electrical connection member 3, which is fixed to the insulator 2. The electrical connection member 3 is in electrical contact with both the PE terminal 111 and the A-terminal 121 to electrically connect the A-terminal 121 to the PE terminal 111. In this way, the A-terminal 121 and the PE terminal 111 can be grounded together, which can effectively prevent the low-voltage auxiliary circuit of the DC charging dock from being burned out.

The electrical connection member 3 includes a first contact part 31, a second contact part 32, and a connection part 30. The first contact part 31 is in electrical contact with the PE terminal 111. The second contact part 32 is in electrical contact with the A-terminal 121. The connection part 30 electrically connects the first contact part 31 and the second contact part 32. The connection part 30 is fixed to the insulator 2, and the first contact part 31 and the second contact part 32 are exposed from the outside of the insulator 2.

The insulator 2 is directly injection molded onto the electrical connection member 3 and the conductive lead 6, making the insulator 2, the electrical connection member 3, and the conductive lead 6 an integrated piece. In the illustrated embodiment, the electrical connection member 3 is an integral stamped part.

The first contact part 31 includes a pair of first spring pieces. The pair of first spring pieces is used to clamp the PE terminal 111. The second contact part 32 includes a pair of second spring pieces. The pair of second spring pieces is used to clamp the A-terminal 121.

The insulator 2 has a first locking part 210. The first locking part 210 is pressed against the PE terminal 111 to lock the PE terminal 111 in the charging dock housing 1. The insulator 2 has a second locking part 220. The second locking part 220 is pressed against the A-terminal 121 to lock the A-terminal 121 in the charging dock housing 1.

The PE terminal assembly 110 further includes a grounding cable (not shown) and a first sealing component 112. The grounding cable is electrically connected to the PE terminal 111 and led out from the first socket 11 of the charging dock housing 1. The first sealing component 112 is injected onto the PE terminal 111. The first sealing component 112 is compressed between the PE terminal 111 and the inner wall surface of the first socket 11 to achieve sealing between the two.

The A-terminal assembly 120 further includes a second sealing component 122, which is injection molded onto the A-terminal 121. The second sealing component 122 is compressed between the A-terminal 121 and the inner wall surface of the second socket 12 to achieve sealing between the two.

The axial direction of the socket 13, the axial direction of the first socket 11, and the axial direction of the second socket 12 are parallel to each other, and the axial direction of the insertion slot 14 is perpendicular to the axial direction of the socket 13. The low-voltage module 100 is inserted into the insertion slot 14 along the radial direction of the socket 13.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A power terminal for a charging dock, comprising:
a cylindrical part adapted to mate with a mating power terminal; and
a welding part connected to a rear end of the cylindrical part and adapted to be welded to a high-voltage cable, the welding part having first and second sides opposite in a thickness direction, the first side of the welding part is adapted to be welded to the high-voltage cable, a protrusion is formed on the second side of the welding part and is adapted for thermal contact with a thermal pad of the charging dock for transferring hear to a temperature sensor of the charging dock.

2. The power terminal according to claim 1, wherein the protrusion is adjacent to or connected to the rear end of the cylindrical part of the power terminal.

3. The power terminal according to claim 1, wherein the power terminal is an integral machined part or an integral stamped part.

4. The power terminal according to claim 1, wherein the protrusion is semi cylindrical.

5. A power terminal assembly, comprising:
the power terminal according to claim 1; and
a high-voltage cable, one end of which is welded to the first side of the welding part of the power terminal.

6. The power terminal assembly according to claim 5, further comprising a sealing ring which is fitted onto the cylindrical part of the power terminal, the sealing ring is adapted to be compressed between the cylindrical part of the power terminal and an inner wall surface of a charging dock housing.

7. The power terminal assembly according to claim 5, wherein a seal installation groove is formed on the cylindrical part of the power terminal, and the sealing ring is installed in the seal installation groove.

8. The power terminal assembly according to claim 5, further comprising a sealing plug fitted onto the high-voltage cable, the sealing plug is adapted to be compressed between the high-voltage cable and the inner wall surface of the charging dock housing.

9. A charging dock, comprising:
a charging dock housing formed with a socket; and
the power terminal assembly according to claim 5 inserted into the socket.

10. The charging dock according to claim 9, wherein multiple sockets are formed in the charging dock housing, and the charging dock includes multiple power terminal assemblies respectively inserted into the multiple sockets.

11. The charging dock according to claim 9, wherein:
an insertion slot in communication with the socket is formed in the charging dock housing; and
the charging dock further includes a low-voltage module adapted to detect the temperature of the power terminal, wherein the low-voltage module is installed in a pluggable manner from the outside of the charging dock housing into the insertion slot.

12. The charging dock according to claim 11, wherein the low-voltage module comprises:
an insulator;
a thermal pad assembled onto the insulator for thermal contact with the protrusion of the power terminal;
a temperature sensor provided in the thermal pad and adapted to detect the temperature of the power terminal; and
a conductive lead provided in the insulator and electrically connected to the temperature sensor, the thermal pad is in thermal contact with the protrusion of the power terminal to transfer the heat of the power terminal to the temperature sensor.

13. The charging dock according to claim 12, wherein the insulator is directly injection molded onto the conductive lead forming an integrated piece.

14. The charging dock according to claim 12, wherein the conductive lead has a connection end electrically connected to the temperature sensor and an external pin for electrical connection with a connector located outside the charging dock housing.

15. The charging dock according to claim 14, wherein the insulator comprises:
a bracket part adapted for insertion into the insertion slot of the charging dock housing; and
a mating part adapted to be positioned outside the charging dock housing, the thermal pad and the temperature sensor are installed on the bracket part, and the mating part has an insertion cavity that allows a connector to be inserted, the external pin of the conductive lead extends into the insertion cavity to be electrically connected to the inserted connector.

16. The charging dock according to claim 15, wherein a sealing ring installation groove is formed on an outer peripheral surface of the bracket part, and the low-voltage module further comprises a sealing ring installed in the sealing ring installation groove, wherein the sealing ring is adapted to be compressed between the bracket part and the inner wall surface of the insertion slot of the charging dock housing to achieve sealing between the two.

17. The charging dock according to claim 15, wherein:
the bracket part has a cover plate part for covering the entrance of the insertion slot of the charging dock housing, and the insulator includes multiple buckles connected to the periphery of the cover plate part, which are distributed at intervals around an outer periphery of the cover plate part; and
multiple protrusions are formed on the outer side of the peripheral wall of the insertion slot of the charging dock housing, which are distributed around the insertion slot at intervals and respectively engage with the multiple buckles to lock the low-voltage module to the charging dock housing.

18. The charging dock according to claim 15, wherein:
the conductive lead comprises a positive lead and a negative lead electrically connected to the positive pin and the negative pin of the temperature sensor, respectively; and
the external pins of the positive lead and the negative lead extend into the insertion cavity of the mating part for electrical connection with the inserted connector.

19. The charging dock according to claim 18, wherein at least one of:
the connection end of the positive lead is adapted to form a plug-in electrical connection with the positive pin of the temperature sensor; and
the connection end of the negative lead adapted to form a plug-in electrical connection with the negative pin of the temperature sensor.

20. The charging dock according to claim 19, wherein at least one of:
the connection end of the positive lead is in an elastic clip shape adapted to clamp the positive pin of the temperature sensor; and
the connection end of the negative lead is in an elastic clip shape adapted to clamp the negative pin of the temperature sensor.

21. The charging dock according to claim 18, wherein the low-voltage module comprises multiple thermal pads and multiple temperature sensors respectively arranged in the multiple thermal pads, the multiple thermal pads are used to respectively make thermal contact with multiple power terminals, and the multiple temperature sensors are used to respectively detect the temperature of the multiple power terminals.

22. The charging dock according to claim 21, wherein:
the conductive lead comprises multiple positive leads and a single negative lead;
the connection ends of the multiple positive leads are respectively electrically connected to the positive pins of the multiple temperature sensors, and the single negative lead has multiple connection ends respectively electrically connected to the negative pins of the multiple temperature sensors; and
the external pins of the multiple positive leads and the external pin of the single negative lead extend into the insertion cavity of the mating part for electrical connection with the inserted connector.

23. The charging dock according to claim 18, wherein:
the thermal pad is block shaped, and a recessed receiving part is formed on the insulator, the thermal pad is positioned and installed into the receiving part; and
a mounting slot is formed in the thermal pad, and the main body of the temperature sensor is inserted into the mounting slot of the thermal pad, the positive pin and negative pin of the temperature sensor extend from the thermal pad.

24. The charging dock according to claim 23, wherein the thermal pad has an arc-shaped contact surface suitable for being attached to the outer peripheral surface of the power terminal to increase the thermal contact area between the thermal pad and the power terminal.

25. The charging dock according to claim 12, wherein:
the charging dock is a DC charging dock, and a first socket and a second socket are formed in the charging dock housing, the insertion slot is communicated with the first socket and the second socket;
the charging dock further comprises:
a positive earth (PE) terminal assembly comprising a positive earth terminal and inserted into the first socket; and
a low-voltage terminal assembly, comprising an A-terminal and inserted into the second socket; and
the low-voltage module further comprises an electrical connection member fixed to the insulator, the electrical connection member is in electrical contact with both the PE terminal and the A-terminal to electrically connect the A-terminal to the PE terminal.

26. The charging dock according to claim 25, wherein the electrical connection member comprises:
a first contact part in electrical contact with the PE terminal;
a second contact part in electrical contact with the A-terminal; and
a connection part that electrically connects the first contact part and the second contact part, the connection part is fixed to the insulator, and the first contact part and the second contact part are exposed from the outside of the insulator.

27. The charging dock according to claim 25, wherein the insulator is directly injection molded onto the electrical connection member and the conductive lead, making the insulator, the electrical connection member, and the conductive lead an integrated piece.

28. The charging dock according to claim 26, wherein the electrical connection member is an integral stamped part.

29. The low-voltage module according to claim 26, wherein at least one of:
the first contact part comprises a pair of first spring pieces adapted to clamp the PE terminal; and
the second contact part comprises a pair of second spring pieces adapted to clamp the A-terminal.

30. The charging dock according to claim 25, wherein at least one of:
the insulator has a first locking part that rests against the PE terminal to lock the PE terminal in the charging dock housing; and
the insulator has a second locking part that rests against the A-terminal to lock the A-terminal in the charging dock housing.

31. The charging dock according to claim 25, wherein the PE terminal assembly further comprises:
a grounding cable, electrically connected to the PE terminal and led out from the first socket of the charging dock housing; and
a first sealing component which is injection molded onto the PE terminal, the first sealing component is compressed between the PE terminal and the inner wall surface of the first socket to achieve sealing between the two.

32. The charging dock according to claim 25, wherein the A-terminal assembly further comprises a second sealing component which is injection molded onto the A-terminal, the second sealing component is compressed between the A-terminal and the inner wall surface of the second socket to achieve sealing between the two.

33. The charging dock according to claim 25, wherein the axial direction of the socket, the axial direction of the first socket, and the axial direction of the second socket are parallel to each other, and the axial direction of the insertion slot is perpendicular to the axial direction of the socket, the low-voltage module is inserted into the insertion slot along the radial direction of the socket.

34. The charging dock according to claim 9, wherein the charging dock housing is an integral injection molded part.
